(19) United States
(12) Patent Application Publication
(10) Pub. No.: US 2012/0166085 A1
(43) Pub. Date: Jun. 28, 2012

(54) SOLAR POWER MONITORING AND PREDICTING OF SOLAR POWER OUTPUT

(76) Inventor: PETER GEVORKIAN, LA CANADA FLINTRIDGE, CA (US)

(21) Appl. No.: 13/325,616

(22) Filed: Dec. 14, 2011

Related U.S. Application Data
(60) Provisional application No. 61/459,531, filed on Dec. 14, 2010.

(51) Int. Cl. G06F 19/00; G01W 1/10

(52) U.S. Cl. 702/3; 702/62

(57) ABSTRACT

A computer to improve prediction of solar output for a solar power system that includes a processor and a memory. The memory has software code which when executed causes the computer to receive power output data from the solar power system, calculate a statistical mean of the power output data, receive solar hour information from an almanac system and generate an almanac predicted power output for the solar power system for the specified time period. The computer receives weather information for the specified time period from a weather predicting source and calculates a weather prediction-to-solar almanac ratio based on a comparison of the solar hour information to the weather information. The computer generates a predicted power output for the specified time period by multiplying the almanac predicted power output for the solar power system by the weather prediction-to-solar almanac ratio and stores the predicted power output for the specified time period.

### RELATED APPLICATIONS

This application is a non-provisional patent application claiming priority to provisional patent application 61/459,531, filed Dec. 14, 2010.

### BACKGROUND OF THE INVENTION

Solar panels are now being utilized in commercial and residential installations to provide operating power. As with any electrical power system, safety is of paramount importance for a solar power system. Solar photovoltaic power energy production systems are subject to energy output variations because of constant environmental and climatic temperature changes. In large grid integrated solar power generation systems stability and predictability of energy production are of paramount importance.

Many solar power producers are large energy providers. Solar power producers, similar to conventional coal or gas fired electrical power generation plants, are required to provide transmission and distribution organizations with their predictable capacity of energy supply. This issue which has thus far not been achieved by solar power system technologies due to the unpredictability of temperature and other environmental conditions.

Accordingly, there is a need for solar power predictability software algorithms that utilize specific statistical and analytic methodology to combine accumulated historical energy performance information, which is form-fitted with environmental and real time climate-forecast statistical information to provide specific time dependent solar energy production envelopes. There is also a need to be able to define solar power system energy production probability for specific duration of time (e.g., day or weeks).

### BRIEF DESCRIPTION OF THE FIGURES

Block Diagram A describes the process for acquiring specific types of system generated data at the PV module, including voltage, current and temperature;

Block Diagram B describes the process through which the data acquisition is synchronized within the system;

Block Diagram C describes the process by which the data collection mechanism at each PV module sends or transmits information to the master station;

Block Diagram D describes a field weather monitoring station and systems for acquiring general information on climate conditions and transmitting it to the master station for processing;

Block Diagram E describes the process by which the master station receives data from PV modules and weather stations;

Block Diagram F describes the topology and physical configuration of the solar system and the process for tagging each component within the system;

Block Diagram G describes the method for processing raw data acquired from the field and a normalization process with reference to baseline data based on external environmental conditions;

Block Diagram H describes the process for acquiring and comparing normalized data referenced;

Block Diagram J describes a process for obtaining and comparing normalized data to Raw Data relating to a string of PV modules;

Block Diagram K describes a process for converting PV normalized power measurement into a normalized string, combiner box, and/or recombiner box (string/CB/RCB) power;

Block Diagram L describes a process for obtaining and comparing normalized data to Raw Data at both the combiner box and recombiner box levels (i.e. a series of strings makes up a combiner box; a series of combiner boxes make up a recombiner box);

Block Diagram M describes a process similar to that referenced in Block Diagram K for acquiring and comparing data relating to the performance of the inverter and total power generated by the system;

Block Diagram N describes the process and algorithm for prognosticating or predicting solar power output for a specified time period;

FIG. 1 illustrates results of the comparison of the prognosticated solar power to the NOAA/Almanac form fitted profile;

FIGS. 2 and 3 are graphical representations of the comparison of prognosticated NOAA compensated kilowatt hours (from N6) vs. the prognosticated kilowatt hours based on actual power output;

FIG. 4a illustrates a block diagram of a solar power system and a solar power prediction system according to an embodiment of the invention; and

FIG. 4b illustrates a flowchart of predicting solar power production according to an embodiment of the invention.

### DETAILED DESCRIPTION OF THE EMBODIMENTS

The present invention relates to a system and process for generating and using data and information for predicting the level of power production by a Photo Voltaic solar system. In general, the system and process involves a process for gathering, storing and time stamping data acquired at each PV module included in the solar system (also referred to the acquisition of data at the sub-system level), and then transmitting the data to a master station for further processing. The system for collecting data at the PV module level and transmitting it to a master station for processing is referred to as the Wireless Intelligent Solar Power Reader (WISPR) Structure and Process, which is the subject of U.S. patent application Ser. No. 12/487,564, filed Jun. 16, 2009, which is incorporated herein by reference (and herein referred to as the “WISPR Application”).

In an illustrative embodiment of the invention, the master station collects data from each PV module or node in the system. At the master station, the information is received, stored and processed and compared with other information acquired from the system through the application of proprietary algorithms. This information is then used to predict the solar power output level that is likely to be generated by the system for a specified period of time (e.g., 15 days, 30 days, 3 months).

Block Diagrams A-N describe the system for gathering data, generating additional data and predicting the level of power production by a PV solar system according to an embodiment of the invention. Each reference letter number combination (e.g., E1, D2, C5), represent an automatic process, program, or subroutine that results in the master station receiving data, transmitting data, comparing data, generating data, generating results or displaying data. Some or all these aspects of the invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (which may include volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

Block Diagram A describes the process for acquiring specific types of system generated data at the PV module, including voltage, current and temperature. After the data is collected, it is converted from analog to digital format and then stored through a buffer register. At the time the information is stored it is time stamped so as to provide for data collection in synchronous fashion from all PV modules in the system. The synchronous data collection is made possible through the generation of a signal from the master station which gives a command to the data collection unit at each PV module to initiate the data acquisition process. This data acquisition process is described in more detail in Block Diagram E.

Block Diagram B describes the process through which the data acquisition is synchronized within the system. This is achieved through a master clock that resides inside the data acquisition unit attached to each PV module. The master clock initiates a command for collecting particular data in a specific sequence. The data collected in analog form is then converted to digital format and stored for further processing. This process can be repeated as frequently as needed to ensure synchronized collection of information and data throughout the system.

Block Diagram C describes the process by which the data collection mechanism at each PV module sends or transmits information to the master station. C2 and C3 represent to a process or algorithm through which the information and its source are identified and confirmed. This process is more specifically described in the Related Application. C4 represents the component that receives information from the master station concerning the functionality of the corresponding PV module and the status of power generated at the PV module. C6 corresponds to the module output latch which provides the functionality for turning the power source on or off (i.e. the PV module which is the source where power is generated).

Block Diagram D describes a field weather monitoring station and systems for acquiring general information on climate conditions and transmitting it to the master station for processing. The data collected includes such data as ambient temperature, barometric pressure, solar irradiance and wind speed etc. The independent weather stations are positioned in appropriate locations within the solar power system, and information acquired at the weather stations is synchronized or matched up with corresponding data collected at the sub-system level (i.e., the PV modules).

Block Diagram E describes the process by which the master station receives data from PV modules and weather stations. The information and data collected at the master station is compared and processed by a central data acquisition system. E11 represents the process or algorithm for receiving data (measurements) from PV modules in the field (and is also capable of transmitting commands back to the PV modules). E8 represents the process or algorithm for receiving data from the National Oceanic Atmospheric Association (NOAA) and processing the data. E5 represents the process or algorithm for receiving data from the weather stations on the field. E2 represents the step at which information is processed. E1 represents the process or algorithm for displaying the processed information. E3 represents a communications system incorporating protocols for sending and receiving data. E4 represents data corresponding to the map of the solar system, or its topology (which is identified when the system is initiated at the time of installation). E7 represents a data entry process or algorithm (including GPS coordinates of the solar system). E10 represents the process or algorithm for identifying information concerning the specifications of the PV modules and all other solar power system components (involving data entry). E6 represents the process (or algorithm) for gathering information and storing it for reference purposes. E9 represents the process or algorithm for obtaining data from the solar almanac. E12 represents the process or algorithm for obtaining computed electrical power of each PV module.

Block Diagram F describes the topology and physical configuration of the solar system and the process for tagging each component within the system. Tagging of each component involves assigning a unique address to the component. Figure F1 describes PV modules 1 through n. A series of PV modules form a string, which is described in Figure F2. Figure F3 refers to combiner boxes in the system. A combiner box provides a means of combining multiple strings or source circuits from a PV array into a single DC output. A series of combiner boxes are combined at a re-combiner box, and several re-combiner boxes are connected to an inverter. F4 and F5 represent the re-combiner boxes and inverters, respectively. Aggregated DC power generated by the PV modules is converted to AC power at the inverters. The inverters are connected to an AC accumulator box (or boxes), which is represented by F6. F7 represents the process or algorithm of transforming AC power and F8 represents the process or algorithm through which the power generated by the system is made available to the power grid.

Block Diagram G describes the method for processing raw data acquired from the field and a normalization process with reference to baseline data based on external environmental conditions. Normalizing refers to a process through which baseline data relating to the performance of PV modules is adjusted based on the impact of specified environmental conditions (a mathematical algorithm for each type of condition affecting performance is applied to the baseline performance specifications). The external conditions referenced in Figures G1 through G5 affect performance of PV modules (additional parameters may be added in the future). Each of the G1 through G5 corresponds to the process or algorithm for normalizing the type of data specified in the figure. The data related to environmental conditions referenced in G1 through G5 is acquired using weather stations on the field. E12 represents the process for acquiring raw performance data from each PV module. G9 represents the process or algorithm for storing the data for further processing. Figures G9 and G6 represent the process of comparing the raw data and the normalized data referenced in G1 through G5. G6 represents the automated process for applying the normalization algorithm, and the normalized data is stored through the process represented in G7. The information is used for further processing through the method described in Figure H5 (on Block Diagram H).

G13 represents the process or algorithm for acquiring performance data on the first day of installation and system completion (at which point the system is theoretically functioning at optimal performance). Information acquired through application of the process represented in G13 is used for reference purposes and for further processing data acquired from the field and other sources, as described below. The first day data acquired through the process described in G13 is normalized (i.e. adjusted based on environmental conditions) and then the results are stored as depicted in G13. In general, Block Diagram G refers to four sets of data:

(i) Raw Data (E12), which refers to system field parameter measurement data acquired at each photovoltaic module;

(ii) Spec Data (E10), which refers to manufacturer's photovoltaic module performance specification ATA sheet system performance obtained from the manufacturer of PV modules and other system components;

(iii) First Day Data (G11), which refers to photovoltaic module measured performance data obtained during the first day of operation or system commissioning, which is normalized and stored for the purpose of comparing with future Raw Data acquired (after the first day of operation).

(iv) Statistical Data (G12), which refers to the average of performance measurements taken over time (on a daily, weekly or bi-monthly basis, or as frequently as desired).

The data is used to generate daily and monthly averages (or averages over a different time period as desired). This Statistical Data is used for reference for determining overall system performance and particularly system degradation. Statistical Data is normalized for the purposes of comparing with Raw Data. G12 refers to the process for acquiring this type of data.

G10 represents the automated process (or algorithm) for comparing the Spec Data (E10), First Day Data (G11) and Statistical Data (G12) as available points of reference. G11, G12 & E10 represent the process or algorithm for normalizing the comparative data generated through the process represented by G10. The information and data is transmitted for further processing as reflected in H1.

In general, Spec Data will be most directly used for purposes of reference and comparison to Raw Data. The comparison algorithm referenced in G13 is referred to as the “Reference Dynamic Data.”

In general, various data sets are compared to one another to obtain measurements used for reference purposes. For example, Spec Data is compared with Statistical Data and the deviation is used for further reference. If the information concerning degradation is consistent with Spec Data (e.g. Spec Data may indicate degradation of 2% per annum), then that information is used for reference purposes—and thus becomes the Reference Dynamic Data. The Reference Dynamic Data is used for comparison to Raw Data. The Reference Dynamic Data is continuously updated and used for reference purposes.

Block Diagram H describes the process for acquiring and comparing normalized data referenced in G7 and E12. The deviation between the data sets represented in G7 and E12 (and gathered in G7 and E12) are compared through the process referenced in H1. The data sets represented by in G7 and E12 deviations are compared and if the deviation is within an expected range, the information is stored and available for further processing through the process represented by H8. If the deviation is outside the expected range, the data is processed through the method represented by H2 and H3. If the deviation is outside the expected performance range and also outside a predetermined operational range (i.e. significantly outside the performance range), the information is used for further processing and application of the mitigation procedures represented by H4. If the deviation is outside the expected performance range and within a predetermined operational range (i.e. moderately outside the performance range), it is used to initiate the mitigation procedures represented by H5. H6 represents the process (or algorithm) for logging an alarm indicating problems in system performance. The process represented by Block Diagram H (starting with the process or algorithm represented by H1 is repeated until the performance data is within an expected range (or normal), in which case the data is used to reset the alarm through the process represented by H7. H8 represents the process or algorithm for storing Raw Data once it is determined that the deviation between the points of reference calculated in G7 and E12 is within an expected or “normal” range. H9 represents the process or algorithm of computing string data from PV module data.

Block Diagram J describes a process for obtaining and comparing normalized data to Raw Data relating to a string of PV modules. This is analogous to the corresponding process described in relation to PV modules in the prior block diagrams and this general process flow is also applied as standard process for combiner box and recombiner box power output.

Block Diagram K describes a process for converting PV normalized power measurement into a normalized string, combiner box, and/or recombiner box (string/CB/RCB) power. K1 describes a retrieval process from data storage buffer. K2 describes the formation of stored PV normalized power data order for conversion to string/CB/RCB power. K3 describes string/CB/RCB conversion process. K4 describes a string/CB/RCB power data comparison process with that of standard string/CB/RCB reference value. K11 describes a data entry process for inputting standard PV module specification. K12 describes a process for constructing a string/CB/RCB reference value from standard PV modules. K5 describes a decision making process for verifying data values. K6 describes a process for determining the alarm category. K7 and K8 describe a process for storing alarm categories. K9 describes a process for storing and registering alarm status. K10 describes a process for storing finalized process measurement data for further processing by block L1.

Block Diagram L describes a process for obtaining and comparing normalized data to Raw Data at both the combiner box and recombiner box levels (i.e. a series of strings makes up a combiner box; a series of combiner boxes make up a recombiner box). This is analogous to the corresponding process described in relation to a string of PV modules in Block Diagram J.

Block Diagram M describes a process similar to that referenced in Block Diagram K for acquiring and comparing data relating to the performance of the inverter and total power generated by the system.

Block Diagram N describes the process and algorithm for prognosticating or predicting solar power output for a specified time period according to an embodiment of the invention. This is accomplished through the use and application of the comparative data and information obtained through the processes described in prior block diagrams. N1 represents the computer-implemented process or algorithm for storing power output data acquired through the power determination process described in M16. N2 represents the computer-implemented process or algorithm for calculating the statistical mean of the power output generated by the system. N3 represents the computer-implemented process or algorithm for forming weekly or bi-monthly solar insolation profiles based on the solar almanac. The almanac provides information on the average number of solar hours (or solar irradiance) per month which is then used to produce an insolation profile or curve (i.e. graph showing the average number of solar hours and the solar pattern based on the almanac). Insolation profile refers to a graph showing the average number of solar hours for a specified interval or time period. The solar almanac profiles are received automatically and stored in to the master station computer. In an alternative embodiment of the invention, the solar almanac profiles are received via data entry.

N4 represents the computer-implemented process or algorithm for obtaining weather data (weather conditions) from the National Oceanic and Atmospheric Association (NOAA) or some other weather forecasting reference/source. The NOAA information is separately used to produce a graph showing the solar pattern based on this information. The NOAA information is received automatically. Alternatively, the NOAA information may be obtained from the Internet. Information obtained from the NOAA is used to adjust the solar insolation profile obtained from the almanac. This automatic adjustment, performed within the master station computer, is accomplished by overlaying the NOAA insolation profile (or curve) over the insolation profile obtained from the almanac. The process or algorithm of comparing the NOAA data to the almanac data is a process referred to as “form fitting.” The “form fitted” data is then used to prognosticate or forecast daily, weekly, or bi-monthly power output, as is highlighted in the process of N10.

N11 represents the computer-implemented process or algorithm for prognosticating the solar power for a period of time after form fitting the solar energy insolation profile to the calculated power output generated by the system. N5 represents the computer-implemented process or algorithm for developing a NOAA insolation profile or envelope (a curvature) upon receiving the information. N6 represents the computer-implemented process (or algorithm) of form fitting the daily, weekly, or bi-monthly solar almanac insolation profile (a curvature), with that of the NOAA daily, weekly, or bi-monthly solar insolation profile. N7 represents the computation and display process or algorithm of the daily, weekly, or bi-monthly solar power output discrepancy resulting from the normalized insolation differential between the solar almanac profile curve and the NOAA insolation profile curve.

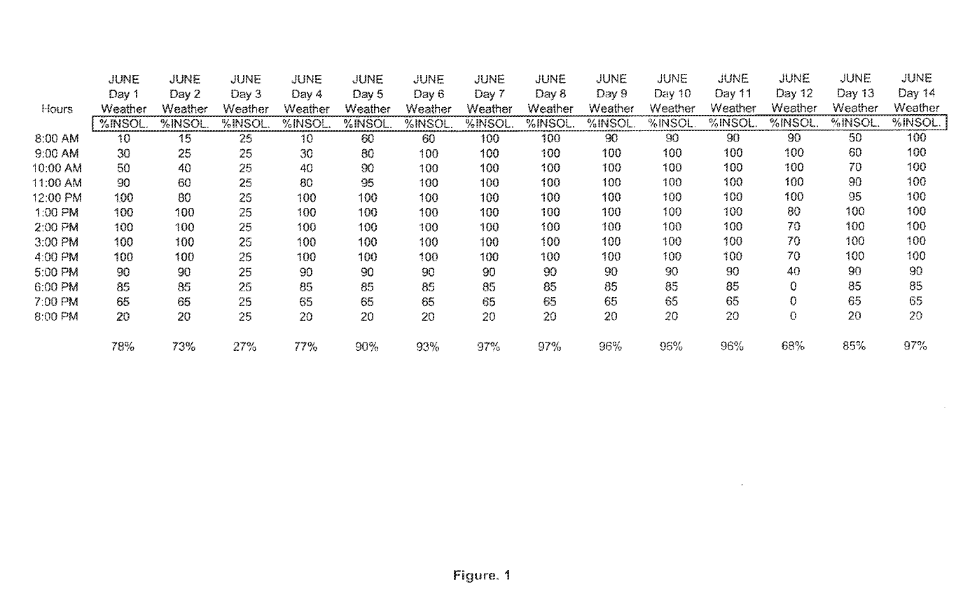

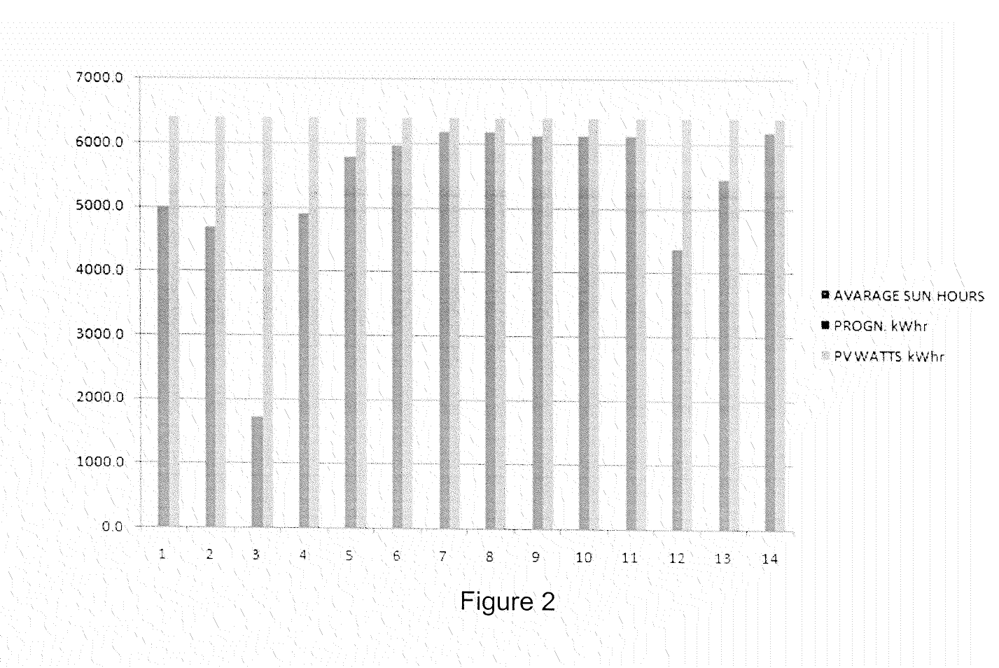

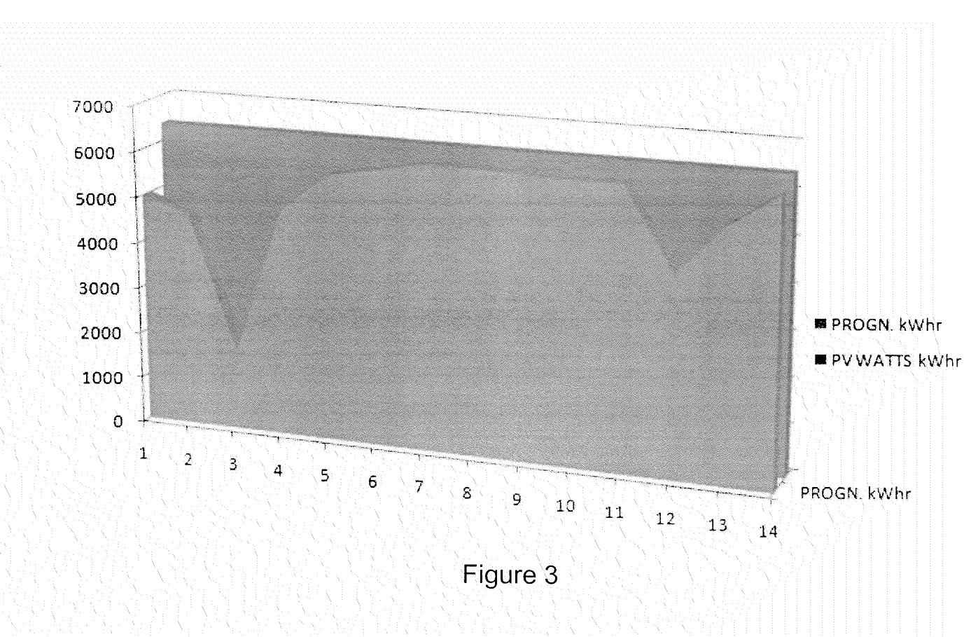

N8 represents the computer-implemented process or algorithm for buffering and storing the solar weekly or bi-monthly insolation profile obtained from the almanac. N9 represents the computer-implemented process or algorithm for establishing a daily, weekly, or bi-monthly prognosticated solar insolation profile by comparing the prognosticated solar power (from N11) to the NOAA/Almanac form fitted profile calculated in N6 (i.e., the comparing of the NOAA data to the almanac data). FIG. 1 illustrates results of the comparison of the prognosticated solar power to the NOAA/Almanac form fitted profile. FIGS. 2 and 3 are graphical representations of the comparison of prognosticated NOAA compensated kilowatt hours (from N6) vs. the prognosticated kilowatt hours based on actual power output. N10 represents the computer-implemented process for computing the prognosticated daily, weekly, or bi-monthly solar power output after the comparison performed in N9. N12 represents or describes the computer-implemented process for storing and displaying the daily, weekly, or bi-monthly prognosticated solar power output.

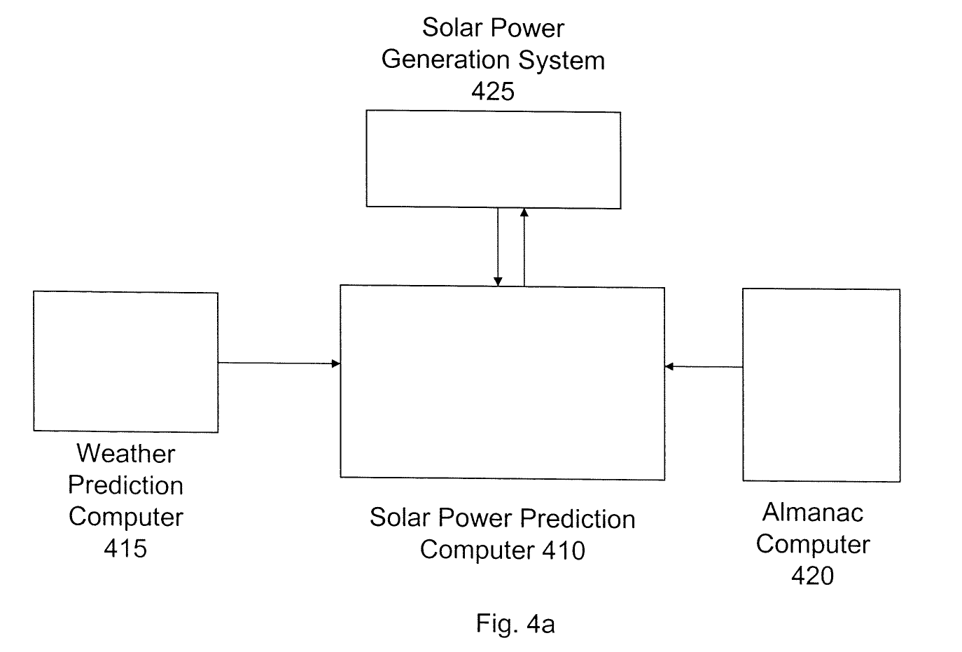

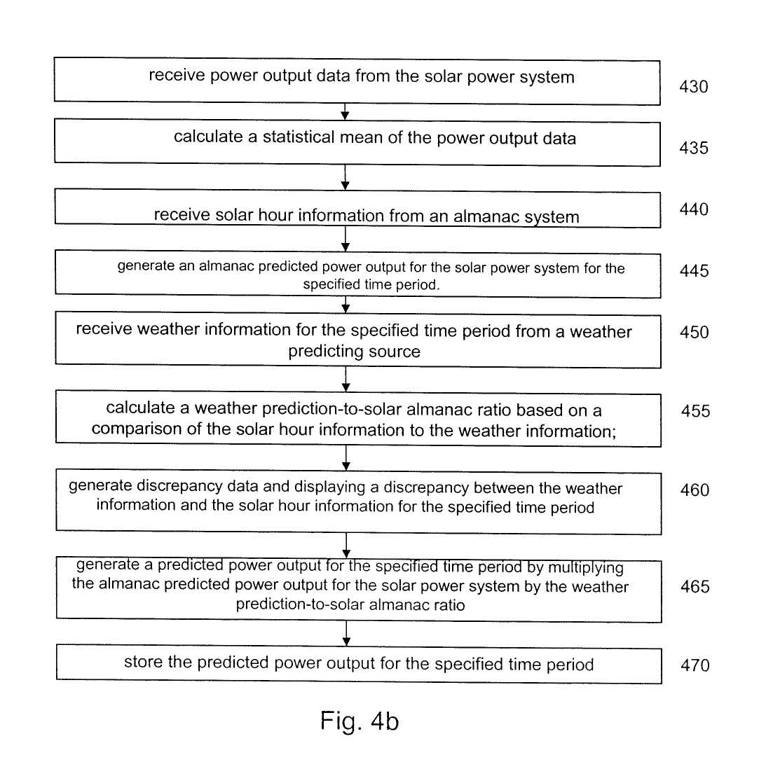

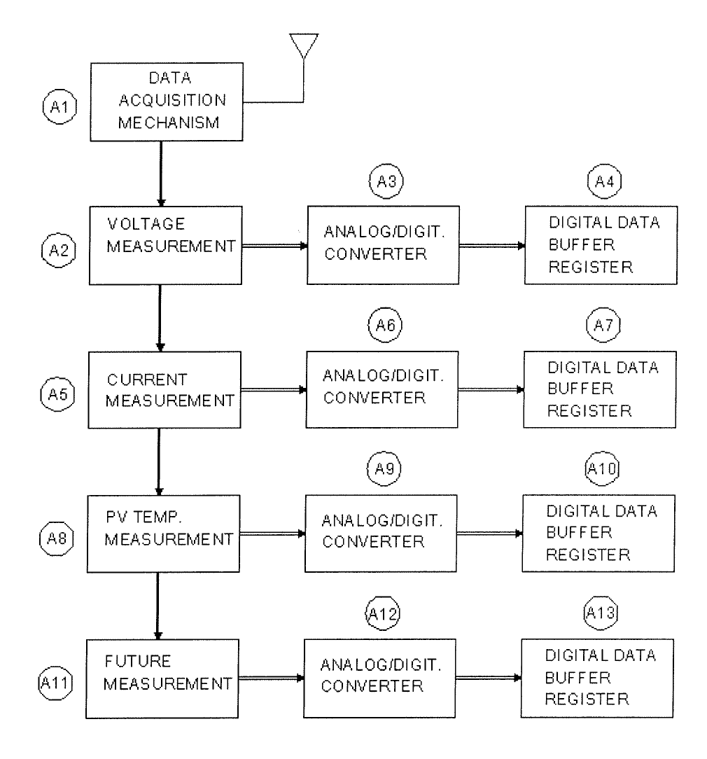

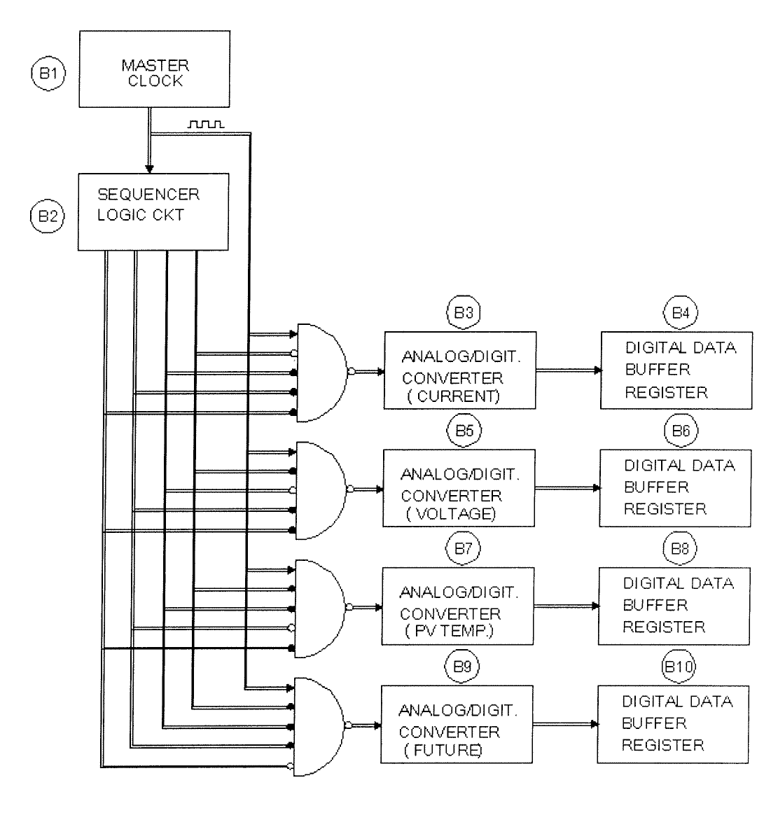

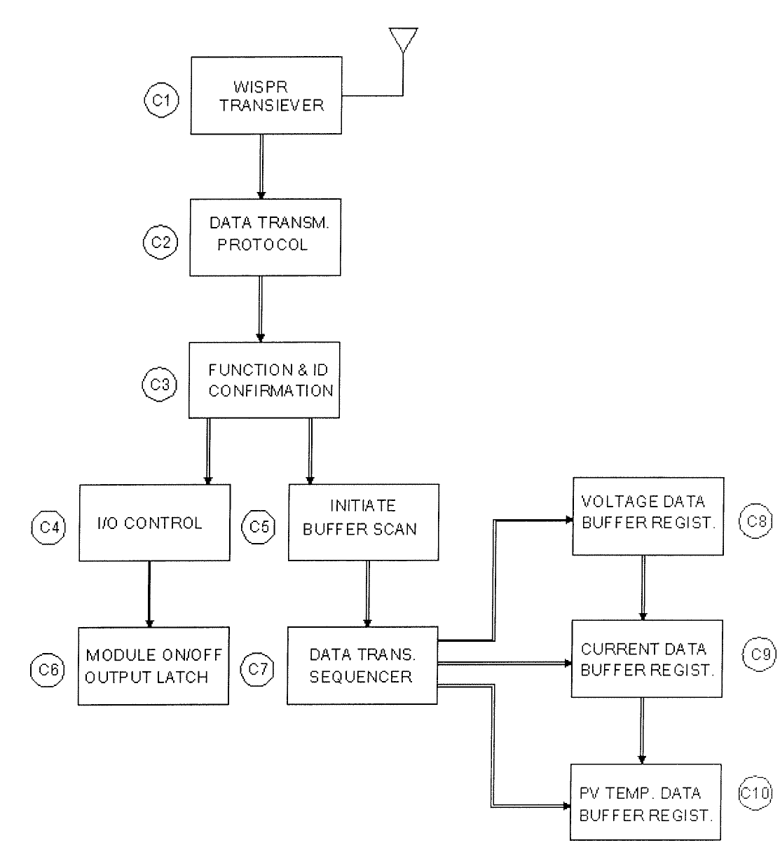

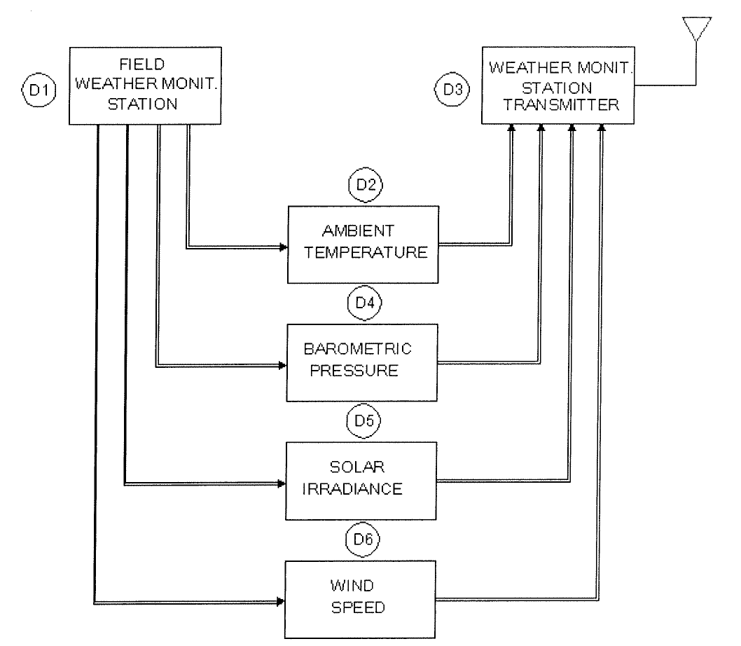

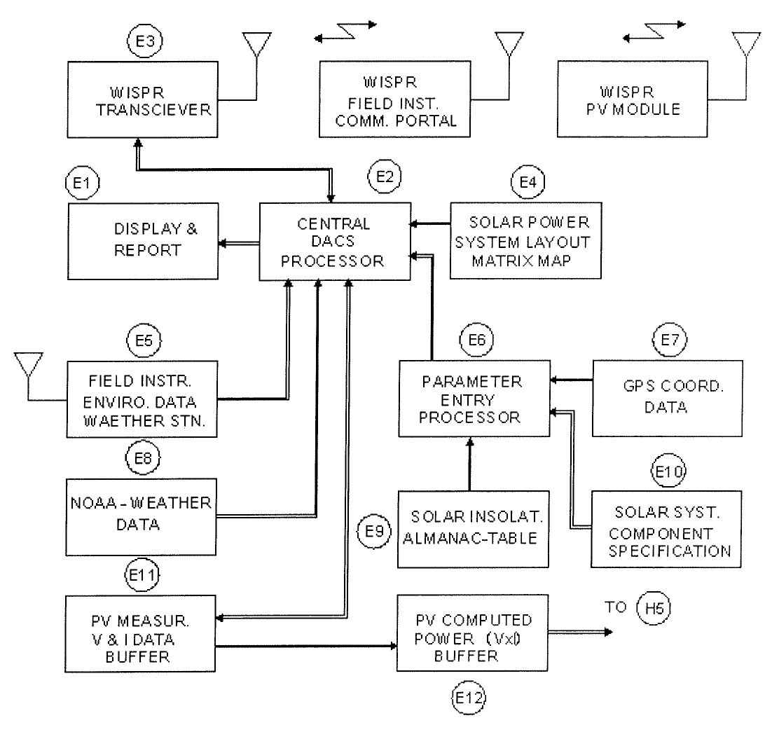

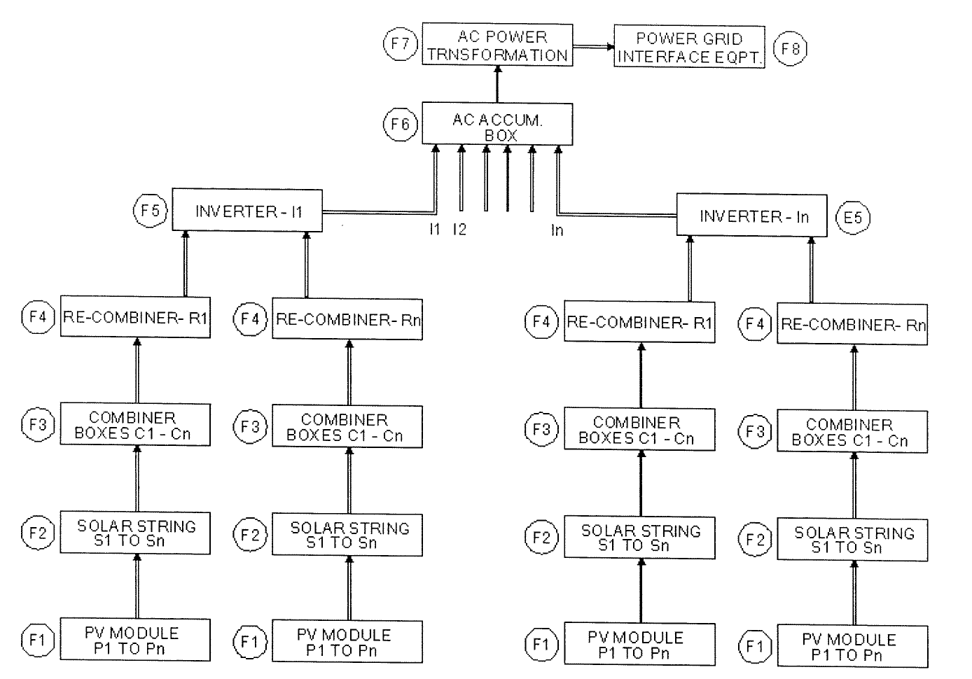

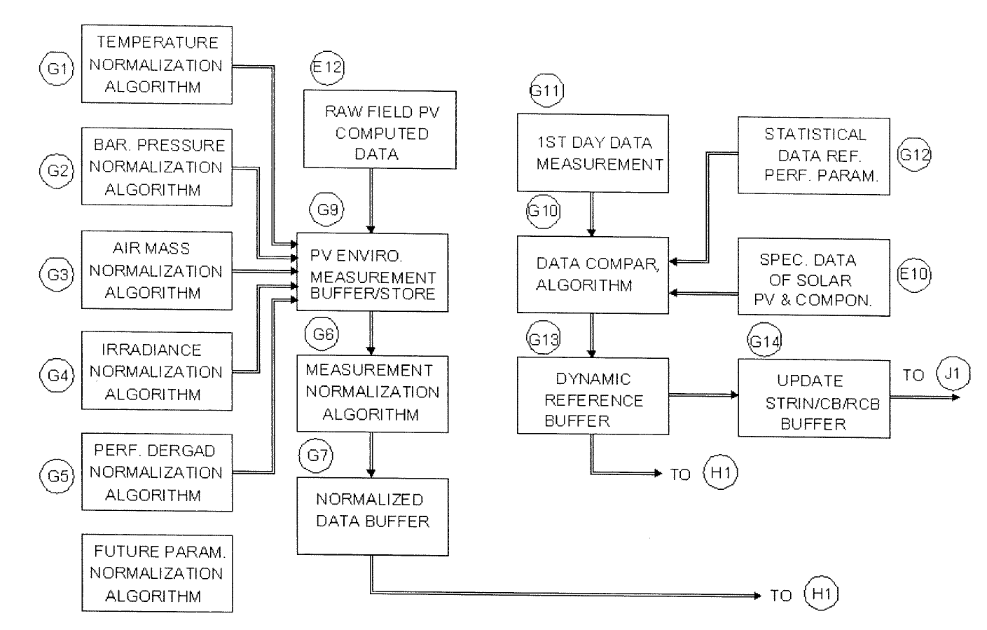

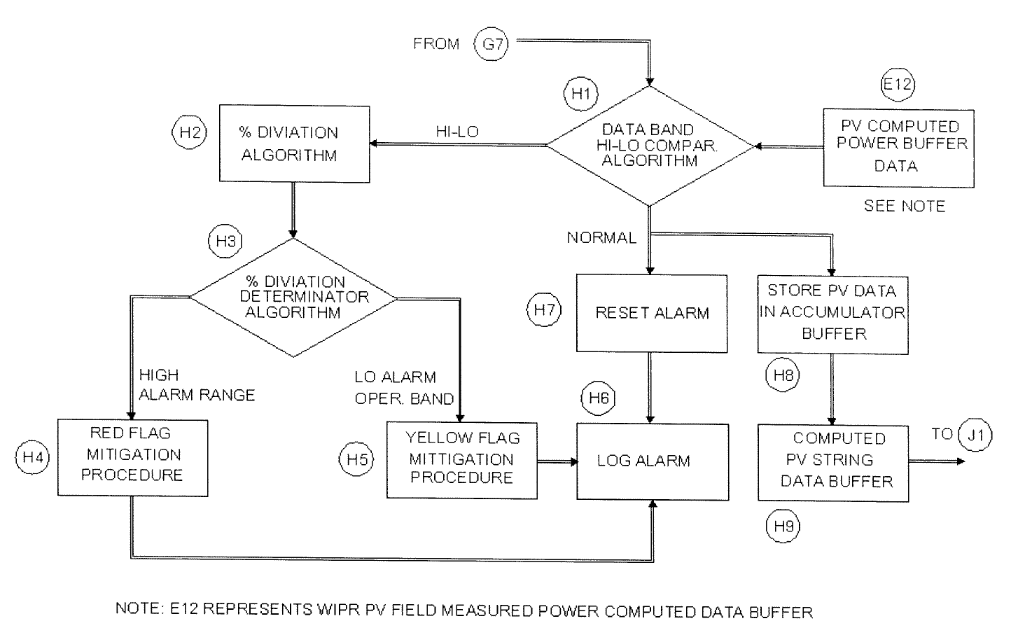

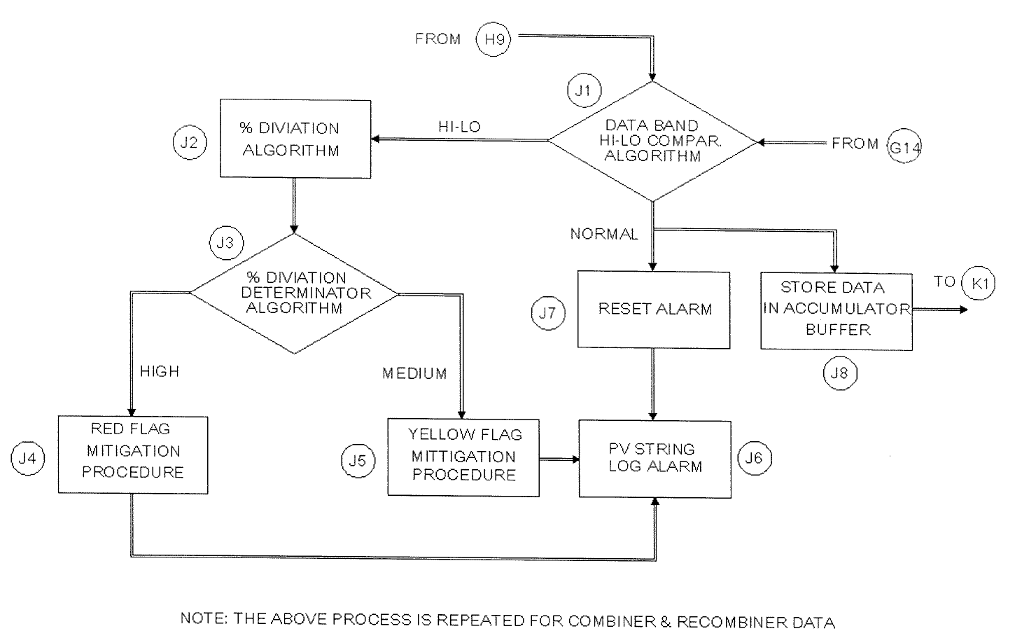

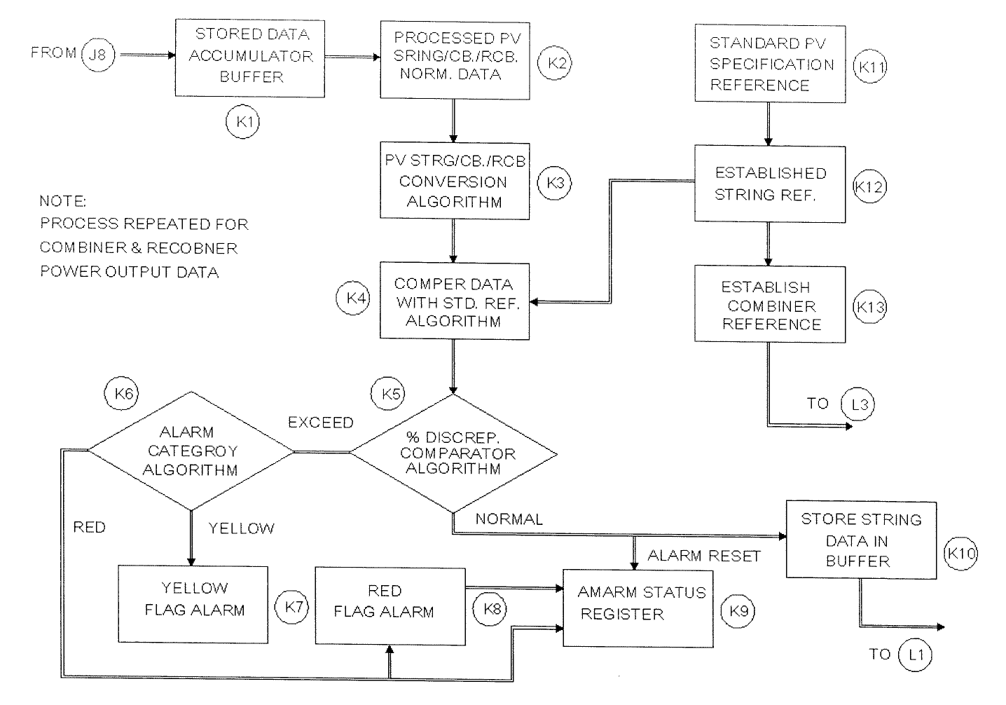

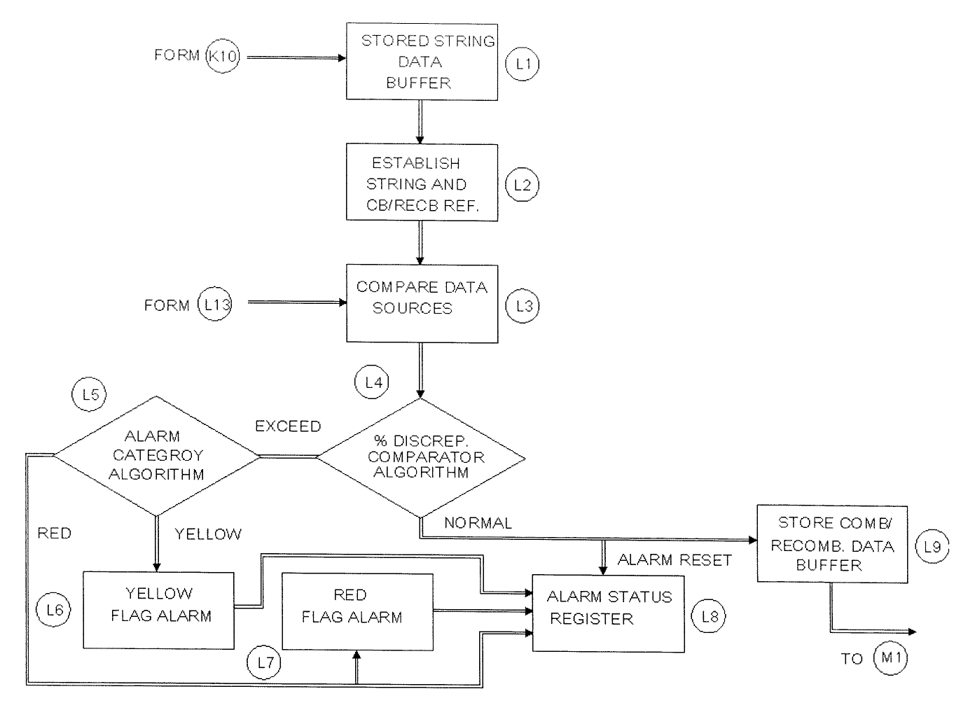

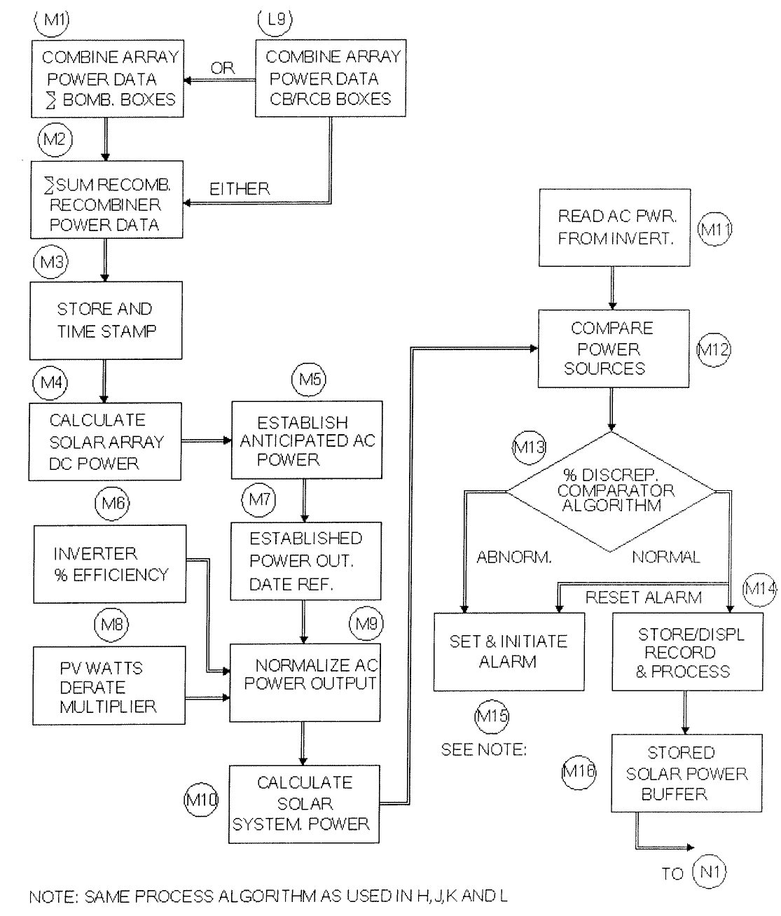

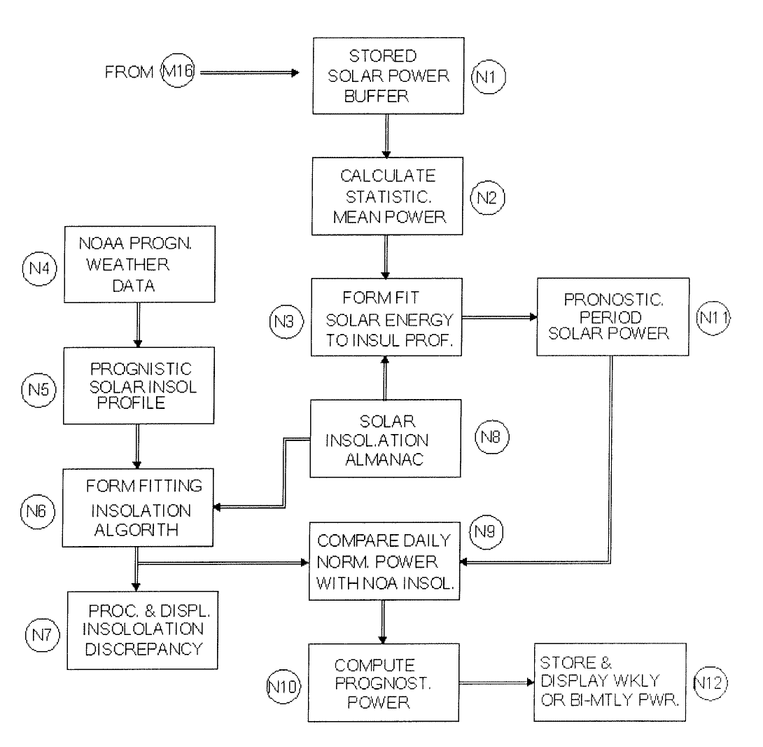

FIG. 4a illustrates a block diagram of a solar power system and a solar power prediction system according to an embodiment of the invention. A solar power prediction computer 410 is coupled to a solar power generation system 425. The solar power prediction computer receives solar power output data from the solar power generation system indicating the energy the solar power generation system has output. The solar power prediction computer 410 is also coupled to an almanac computer 420. The almanac computer provides a predicted number of solar hours for a specified time frame (e.g., a week, a month, a year) and normally provides the daily predicted power output. The solar power production computer 410 is also coupled to a weather prediction computer 415. The weather prediction computer provides data as to the predicted weather for a specified time frame (e.g., a week, two weeks, a month). The data may include cloud cover information, precipitation (rain/snow) or wind information. This information may impact the power output from a solar power generation system.

FIG. 4b illustrates a flowchart of predicting solar power production according to an embodiment of the invention. A solar power prediction computer receives 430 power output data from the solar power system. The solar power prediction computer calculates 435 a statistical mean of the power output data. The solar power prediction computer receives 440 solar hour information from an almanac system. The solar power prediction system generates 445 an almanac predicted power output for the solar power system for the specified time period. The solar power prediction system receives 450 weather information for the specified time period from a weather predicting source. The solar power prediction system calculates 455 a weather prediction-to-solar almanac ratio based on a comparison of the solar hour information to the weather information. The solar power prediction computer generates 460 discrepancy data based on the comparison in step 455. The solar power prediction computer generates 465 a predicted power output for the specified time period by multiplying the almanac predicted power output for the solar power system by the weather prediction to solar almanac ratio. The solar power prediction computer stores the predicted power output for the specified time period.

What is claimed:

1. A computer to improve prediction of solar output for a solar power system, the computer comprising:
a processor, and
a memory, the memory having software code stored therein, the software code when executed by the processor, causes the computer to:
receive power output data from the solar power system;
calculate a statistical mean of the power output data;
receive solar hour information from an almanac system; and
generate an almanac predicted power output for the solar power system for the specified time period.

2. The computer of claim 1, the software code when executed by the processor causes the computer to:
receive weather information for the specified time period from a weather predicting source and
calculate a weather prediction-to-solar almanac ratio based on a comparison of the solar hour information to the weather information;

3. The computer of claim 2, the software code when executed by the processor causes the computer to generate discrepancy data and displaying a discrepancy between the weather information and the solar hour information for the specified time period.

4. The computer of claim 3, the software code when executed by the processor causes the computer to:
generate a predicted power output for the specified time period by multiplying the almanac predicted power output for the solar power system by the weather prediction-to-solar almanac ratio and
store the predicted power output for the specified time period.
